(19) United States
(12) Patent Application Publication
(10) Pub. No.: US 2015/0234464 A1
(43) Pub. Date: Aug. 20, 2015

(54) APPARATUS DISPLAYING ANIMATED IMAGE COMBINED WITH TACTILE OUTPUT

(71) Applicant: NOKIA TECHNOLOGIES OY, Espoo (FI)

(72) Inventor: Marko Tapani Yliaho, Tampere (FI)

(21) Appl. No.: 14/431,295

(22) PCT Filed: Sep. 28, 2012
(86) PCT No.: PCT/IB2012/055199

§ 371 Date: Mar. 25, 2015

(51) Int. Cl. G06F 3/01; G06F 3/041; G06F 3/16; G06T 13/00

(52) U.S. Cl. CPC G06F 3/016; G06T 13/00; G06F 3/0416; G06F 3/16

(57) ABSTRACT

An apparatus comprising: an input configured to receive at least one animated image and at least one metadata, wherein the at least one animated image comprises at least two frames for generating a dynamic region and at least one data region for generating a substantially static region, and the at least one metadata comprises at least one audio/tactile signal data and at least one touch parameter control data; a touch controller configured to receive at least one touch parameter; an image decoder configured to separate the at least one animated image and the at least one metadata, and configured to generate an animated image comprising the substantially static region and the dynamic region; an event decoder configured to decode the at least one metadata of the animated image and determine at least one feedback event based on the at least one touch parameter; and an event output configured to produce an output based on the at least one feedback event, such that the feedback event is associated with the animated image displayed.

### FIELD

The present invention relates to a providing additional functionality for images. The invention further relates to, but is not limited to, display apparatus providing additional functionality for images displayed in mobile devices.

### BACKGROUND

Many portable devices, for example mobile telephones, are equipped with a display such as a glass or plastic display window for providing information to the user. Furthermore such display windows are now commonly used as touch sensitive inputs. In some cases the apparatus can provide a visual feedback and audible feedback when recording a touch input. In some further devices the audible feedback is augmented with a vibrating motor used to provide a haptic feedback so the user knows that the device has accepted the input.

Images and animated images are known. Animated images or cinemagraph images can provide the illusion that the view is watching a video. The cinemagraph are typically still photographs in which a minor and repeated movement occurs. These are particularly useful as they can be transferred or transmitted between devices using significantly smaller bandwidth than conventional video.

### STATEMENT

According to an aspect, there is provided a method comprising: receiving at least one animated image and at least one metadata, wherein the at least one animated image comprises at least two frames for generating a dynamic region and at least one data region for generating a substantially static region, and the at least one metadata comprises at least one audio/tactile signal data and at least one touch parameter control data; receiving at least one touch parameter; separating the at least one animated image and the at least one metadata to generate an animated image comprising the substantially static region and the dynamic region; decoding the at least one metadata of the animated image to determine at least one feedback event based on the at least one touch parameter; and producing an output based on the at least one feedback event, such that the feedback event is associated with the animated image displayed.

Separating the at least one animated image and the at least one metadata to generate an animated image comprising the substantially static region and the dynamic region may comprise reading a header of the metadata to determine at least one feedback event data, wherein the feedback event data may comprise at least one of: a URI link to audio data; a URI link to a tactile data; a URI link to a vibra control data; audio data; tactile data; camera control data; apparatus control data; a URI to text data; text data; and an encoding format of the audio/tactile signal data.

Separating the at least one animated image and the at least one metadata to generate an animated image comprising the substantially static region and the dynamic region may comprise reading a header of the metadata to determine at least one touch parameter control data comprises at least one of: touch location control; touch direction control; touch speed control; vibra control; and the output location for the audio/tactile signal data.

Separating the at least one animated image and the at least one metadata to generate an animated image comprising the substantially static region and the dynamic region may comprise reading a first part of a metadata header to determine at least one of: the at least one feedback event data is an URI to an audio file; the at least one feedback event data is any audio data; the at least one feedback event data is audio data that should be only audible; the at least one feedback event data is audio data that should be only felt as localized haptic feedback; the at least one feedback event data is audio data that should drive a vibra; the at least one feedback event data is proprietary vibra control command data; the at least one feedback event data is control data to take a picture using a front camera; the at least one feedback event data is control data to take a picture using a rear camera; the at least one feedback event data is control data to actuate the camera flash lighting; the at least one feedback event data is control data to make a phone call; and the at least one feedback event data is control data to operate a stored routine within the apparatus.

Separating the at least one animated image and the at least one metadata to generate an animated image comprising the substantially static region and the dynamic region may comprise reading a second part of a metadata header to determine at least one of: the at least one feedback event data includes a FLAC audio data; the at least one feedback event data includes plain AMR-NB audio data; the at least one feedback event data includes plain AAC audio data; the at least one feedback event data includes plain DD+ audio data; the at least one feedback event data includes linear 16-bit PCM audio data; the at least one feedback event data includes a 3GP file; the at least one feedback event data includes an MP4 file; and the at least one feedback event data includes proprietary vibra command data.

Separating the at least one animated image and the at least one metadata to generate an animated image comprising the substantially static region and the dynamic region may comprise reading a part of the metadata header to determine the length of the data.

Decoding the at least one metadata of the animated image to determine at least one feedback event based on the at least one touch parameter may comprise decoding the at least one metadata of the animated image and determine at least one audio/tactile signal based on the at least one touch parameter; and wherein producing an output based on the at least one feedback event, such that the feedback event is associated with the animated image displayed may comprise generating an output based on the at least one audio/tactile signal, such that the audio/tactile signal is associated with the animated image displayed.

Decoding the at least one metadata of the animated image and determine at least one audio/tactile signal based on the at least one touch parameter may comprise at least one of; decoding audio data; decoding tactile effect signal data; decoding vibra effect control data; and decoding at least one of: audio signal data; tactile effect signal data; and vibra effect control data.

Generating an output based on the at least one audio/tactile signal may comprise at least one of: generating an acoustic wave based on the at least one audio/tactile signal; displacing a display to generate an acoustic wave based on the at least one audio/tactile signal; displacing a display to generate a localised tactile displacement based on the at least one audio/tactile signal; generating a vibra displacement based on the at least one audio/tactile signal.

The method may further comprise displaying the animated image comprising the substantially static region and the dynamic region.

Receiving at least one touch parameter may comprise at least one of: determining of at least one object neighbouring a display on which at least one dynamic region of the animated image is output; determining of at least one object neighbouring a display location; determining a size of at least one object neighbouring a display; determining a number of objects neighbouring a display; determining a speed of at least one object neighbouring a display; and determining a direction of at least one object neighbouring a display.

The method may further comprise sensing at least one object neighbouring a display and determining at least one of: an object neighbouring a display on which at least one dynamic region of the animated image is output; a location of at least one object neighbouring a display; a size of at least one object neighbouring a display; a number of objects neighbouring a display; a speed of at least one object neighbouring a display; and a direction of the at least one object neighbouring a display.

Decoding the at least one metadata of the animated image to determine at least one feedback event based on the at least one touch parameter may comprise: comparing the at least one touch parameter control data and the at least one touch parameter; and decoding the at least feedback event from an at least one feedback event data associated with the at least one image touch parameter control data based on a positive comparison.

Decoding the at least one metadata of the animated image to determine at least one feedback event based on the at least one touch parameter may comprise outputting at least one audio/tactile signal based on whether the object neighbouring the display is within an at least one touch parameter control data display location.

Decoding the at least one metadata of the animated image to determine at least one feedback event based on the at least one touch parameter may comprise controlling the output of at least one audio/tactile signal based on the at least one touch parameter.

Controlling the output of at least one audio/tactile signal based on the at least one touch parameter may comprise at least one of: controlling playing the output of the at least one audio/tactile signal; controlling pausing the output of the at least one audio/tactile signal; controlling stopping the output of the at least one audio/tactile signal; controlling rewinding the output of the at least one audio/tactile signal; and controlling fast forwarding the output of the at least one audio/tactile signal.

Decoding the at least one metadata of the animated image to determine at least one feedback event based on the at least one touch parameter may comprise controlling the output of the animated image comprising the substantially static region and the dynamic region based on the at least one touch parameter.

Controlling the output of the animated image comprising the substantially static region and the dynamic region based on the at least one touch parameter may comprise at least one of: controlling playing the output of the animated image; controlling pausing the output of the animated image; controlling stopping the output of the animated image; controlling rewinding the output of the animated image; and controlling fast forwarding the output of the animated image.

According to a second aspect there is provided a method comprising: generating at least one animated image comprising at least two frames for generating a dynamic region and at least one data region for generating a substantially static region to be displayed on a displayed user interface and at least one touch parameter control data; generating at least one feedback event indicator configured to indicate a feedback event to be output; and combining the at least one feedback event indicator with the at least one animated image to be displayed on a displayed user interface.

The combining the at least one feedback event indicator with the at least one animated image to be displayed on a displayed user interface may comprise at least one of: uploading the at least one animated image and the at least one feedback event indicator to a content server; transmitting control data for selecting the at least one animated image and at least one feedback event indicator from a server apparatus; transmitting a multimedia message service message comprising the at least one animated image and the at least one feedback event indicator; transmitting a network message comprising the at least one animated image and the at least one feedback event indicator; transmitting a server message comprising the at least one animated image and the at least one feedback event indicator; and transmitting an application message comprising the at least one animated image and the at least one feedback event indicator.

The at least one feedback event signal indicator may comprise at least one of: apparatus control data; camera control data; text data; a memory location comprising data; a tactile feedback signal file; a recorded audio signal; an indicator for selecting at least one predefined audio signal; at least one base tactile feedback signal; at least one tactile feedback signal processing characteristic; at least one tactile feedback signal processing characteristic value; a tactile feedback signal link to a memory location within an apparatus; and a tactile feedback signal link to a network location external to an apparatus.

Generating at least one feedback event indicator configured to indicate a feedback event to be output may comprise generating at least one tactile effect signal indicator configured to indicate a tactile effect signal to be output and wherein combining the at least one feedback event indicator with the at least one animated image to be displayed on a displayed user interface may comprise combining the at least one tactile effect signal indicator with the at least one animated image to be displayed on a displayed user interface.

Generating at least one animated image comprising at least two frames for generating a dynamic region and at least one data region for generating a substantially static region to be displayed on a displayed user interface and at least one touch parameter control data may comprise at least one of: selecting at least one defined animated image; selecting at least one touch based control indicator; generating at least one defined animated image.

The at least one touch based control indicator may comprise at least one of: a touch location; a defined number of touches; a touch pressure; a touch duration; a touch speed; and a touch direction.

According to a third aspect there is provided apparatus comprising at least one processor and at least one memory including computer code for one or more programs, the at least one memory and the computer code configured to with the at least one processor cause the apparatus to at least: receive at least one animated image and at least one metadata, wherein the at least one animated image comprises at least two frames to generate a dynamic region and at least one data region to generate a substantially static region, and the at least one metadata comprises at least one audio/tactile signal data and at least one touch parameter control data; receive at least one touch parameter; separating the at least one animated image and the at least one metadata to generate an animated image comprising the substantially static region and the dynamic region; decode the at least one metadata of the animated image to determine at least one feedback event based on the at least one touch parameter; and produce an output based on the at least one feedback event, such that the feedback event is associated with the animated image displayed.

Separating the at least one animated image and the at least one metadata to generate an animated image comprising the substantially static region and the dynamic region may cause the apparatus to read a header of the metadata to determine at least one feedback event data, wherein the feedback event data may comprise at least one of: a URI link to audio data; a URI link to a tactile data; a URI link to a vibra control data; audio data; tactile data; camera control data; apparatus control data; a URI to text data; text data; and an encoding format of the audio/tactile signal data.

Separating the at least one animated image and the at least one metadata to generate an animated image comprising the substantially static region and the dynamic region may cause the apparatus to read a header of the metadata to determine at least one touch parameter control data comprises at least one of: touch location control; touch direction control; touch speed control; vibra control; and the output location for the audio/tactile signal data.

Separating the at least one animated image and the at least one metadata to generate an animated image comprising the substantially static region and the dynamic region may cause the apparatus to read a first part of a metadata header to determine at least one of: the at least one feedback event data is an URI to an audio file; the at least one feedback event data is any audio data; the at least one feedback event data is audio data that should be only audible; the at least one feedback event data is audio data that should be only felt as localized haptic feedback; the at least one feedback event data is audio data that should drive a vibra; the at least one feedback event data is proprietary vibra control command data; the at least one feedback event data is control data to take a picture using a front camera; the at least one feedback event data is control data to take a picture using a rear camera; the at least one feedback event data is control data to actuate the camera flash lighting; the at least one feedback event data is control data to make a phone call; and the at least one feedback event data is control data to operate a stored routine within the apparatus.

Separating the at least one animated image and the at least one metadata to generate an animated image comprising the substantially static region and the dynamic region may cause the apparatus to read a second part of a metadata header to determine at least one of: the at least one feedback event data includes a FLAC audio data; the at least one feedback event data includes plain AMR-NB audio data; the at least one feedback event data includes plain AAC audio data; the at least one feedback event data includes plain DD+ audio data; the at least one feedback event data includes linear 16-bit PCM audio data; the at least one feedback event data includes a 3GP file; the at least one feedback event data includes an MP4 file; and the at least one feedback event data includes proprietary vibra command data.

Separating the at least one animated image and the at least one metadata to generate an animated image comprising the substantially static region and the dynamic region may cause the apparatus to read a part of the metadata header to determine the length of the data.

Decoding the at least one metadata of the animated image to determine at least one feedback event based on the at least one touch parameter may cause the apparatus to decode the at least one metadata of the animated image and determine at least one audio/tactile signal based on the at least one touch parameter; and wherein producing an output based on the at least one feedback event, such that the feedback event is associated with the animated image displayed may cause the apparatus to generate an output based on the at least one audio/tactile signal, such that the audio/tactile signal is associated with the animated image displayed.

Decoding the at least one metadata of the animated image and determine at least one audio/tactile signal based on the at least one touch parameter may cause the apparatus to perform at least one of: decode audio data; decode tactile effect signal data; decode vibra effect control data; and decode at least one of: audio signal data; tactile effect signal data; and vibra effect control data.

Generating an output based on the at least one audio/tactile signal may cause the apparatus to perform at least one of: generate an acoustic wave based on the at least one audio/tactile signal; displace a display to generate an acoustic wave based on the at least one audio/tactile signal; displace a display to generate a localised tactile displacement based on the at least one audio/tactile signal; generate a vibra displacement based on the at least one audio/tactile signal.

The apparatus may be caused to further display the animated image comprising the substantially static region and the dynamic region.

Receiving at least one touch parameter may cause the apparatus to perform at least one of: determine of at least one object neighbouring a display on which at least one dynamic region of the animated image is output; determine of at least one object neighbouring a display location; determine a size of at least one object neighbouring a display; determine a number of objects neighbouring a display; determine a speed of at least one object neighbouring a display; and determine a direction of at least one object neighbouring a display.

The apparatus may further be caused to sense at least one object neighbouring a display and determine at least one of: an object neighbouring a display on which at least one dynamic region of the animated image is output; a location of at least one object neighbouring a display; a size of at least one object neighbouring a display; a number of objects neighbouring a display; a speed of at least one object neighbouring a display; and a direction of the at least one object neighbouring a display.

Decoding the at least one metadata of the animated image to determine at least one feedback event based on the at least one touch parameter may cause the apparatus to: compare the at least one touch parameter control data and the at least one touch parameter; and decode the at least feedback event from an at least one feedback event data associated with the at least one image touch parameter control data based on a positive comparison.

Decoding the at least one metadata of the animated image to determine at least one feedback event based on the at least one touch parameter may cause the apparatus to output at least one audio/tactile signal based on whether the object neighbouring the display is within an at least one touch parameter control data display location.

Decoding the at least one metadata of the animated image to determine at least one feedback event based on the at least one touch parameter may cause the apparatus to control the output of at least one audio/tactile signal based on the at least one touch parameter.

Controlling the output of at least one audio/tactile signal based on the at least one touch parameter may cause the apparatus to perform at least one of: play the output of the at least one audio/tactile signal; pause the output of the at least one audio/tactile signal; stop the output of the at least one audio/tactile signal; rewind the output of the at least one audio/tactile signal; and fast forward the output of the at least one audio/tactile signal.

Decoding the at least one metadata of the animated image to determine at least one feedback event based on the at least one touch parameter may cause the apparatus to control the output of the animated image comprising the substantially static region and the dynamic region based on the at least one touch parameter.

Controlling the output of the animated image comprising the substantially static region and the dynamic region based on the at least one touch parameter may cause the apparatus to perform at least one of: play the output of the animated image; pause the output of the animated image; stop the output of the animated image; rewind the output of the animated image; and fast forward the output of the animated image.

According to a fourth aspect there is provided an apparatus comprising at least one processor and at least one memory including computer code for one or more programs, the at least one memory and the computer code configured to with the at least one processor cause the apparatus to: generate at least one animated image comprising at least two frames to generate a dynamic region and at least one data region to generate a substantially static region to be displayed on a displayed user interface and at least one touch parameter control data; generate at least one feedback event indicator configured to indicate a feedback event to be output; and combine the at least one feedback event indicator with the at least one animated image to be displayed on a displayed user interface.

The combining the at least one feedback event indicator with the at least one animated image to be displayed on a displayed user interface may cause the apparatus to perform at least one of: upload the at least one animated image and the at least one feedback event indicator to a content server; transmit control data for selecting the at least one animated image and at least one feedback event indicator from a server apparatus; transmit a multimedia message service message comprising the at least one animated image and the at least one feedback event indicator; transmit a network message comprising the at least one animated image and the at least one feedback event indicator; transmit a server message comprising the at least one animated image and the at least one feedback event indicator; and transmit an application message comprising the at least one animated image and the at least one feedback event indicator.

The at least one feedback event signal indicator may comprise at least one of: apparatus control data; camera control data; text data; a memory location comprising data; a tactile feedback signal file; a recorded audio signal; an indicator for selecting at least one predefined audio signal; at least one base tactile feedback signal; at least one tactile feedback signal processing characteristic; at least one tactile feedback signal processing characteristic value; a tactile feedback signal link to a memory location within an apparatus; and a tactile feedback signal link to a network location external to an apparatus.

Generating at least one feedback event indicator configured to indicate a feedback event to be output may cause the apparatus to generate at least one tactile effect signal indicator configured to indicate a tactile effect signal to be output and wherein combining the at least one feedback event indicator with the at least one animated image to be displayed on a displayed user interface may cause the apparatus to combine the at least one tactile effect signal indicator with the at least one animated image to be displayed on a displayed user interface.

Generating at least one animated image comprising at least two frames to generate a dynamic region and at least one data region to generate a substantially static region to be displayed on a displayed user interface and at least one touch parameter control data may cause the apparatus to perform at least one of: select at least one defined animated image; select at least one touch based control indicator; and generate at least one defined animated image.

The at least one touch based control indicator may comprise at least one of: a touch location; a defined number of touches; a touch pressure; a touch duration; a touch speed; and a touch direction.

According to fifth aspect there is provided an apparatus comprising: an input configured to receive at least one animated image and at least one metadata, wherein the at least one animated image comprises at least two frames for generating a dynamic region and at least one data region for generating a substantially static region, and the at least one metadata comprises at least one audio/tactile signal data and at least one touch parameter control data; a touch controller configured to receive at least one touch parameter; an image decoder configured to separate the at least one animated image and the at least one metadata, and configured to generate an animated image comprising the substantially static region and the dynamic region; an event decoder configured to decode the at least one metadata of the animated image and determine at least one feedback event based on the at least one touch parameter; and an event output configured to produce an output based on the at least one feedback event, such that the feedback event is associated with the animated image displayed.

The image decoder may comprise a header reader configured to read a header of the metadata to determine at least one feedback event data, wherein the feedback event data may comprise at least one of: a URI link to audio data; a URI link to a tactile data; a URI link to a vibra control data; audio data; tactile data; camera control data; apparatus control data; a URI to text data; text data; and an encoding format of the audio/tactile signal data.

The header reader may be configured to read a header of the metadata to determine at least one touch parameter control data comprises at least one of: touch location control; touch direction control; touch speed control; vibra control; and the output location for the audio/tactile signal data.

The image decoder may be configured to read a first part of a metadata header to determine at least one of: the at least one feedback event data is an URI to an audio file; the at least one feedback event data is any audio data; the at least one feedback event data is audio data that should be only audible; the at least one feedback event data is audio data that should be only felt as localized haptic feedback; the at least one feedback event data is audio data that should drive a vibra; the at least one feedback event data is proprietary vibra control command data; the at least one feedback event data is control data to take a picture using a front camera; the at least one feedback event data is control data to take a picture using a rear camera; the at least one feedback event data is control data to actuate the camera flash lighting; the at least one feedback event data is control data to make a phone call; and the at least one feedback event data is control data to operate a stored routine within the apparatus.

The image decoder may be configured to read a second part of a metadata header to determine at least one of: the at least one feedback event data includes a FLAG audio data; the at least one feedback event data includes plain AMR-NB audio data; the at least one feedback event data includes plain AAC audio data; the at least one feedback event data includes plain DD+ audio data; the at least one feedback event data includes linear 16-bit PCM audio data; the at least one feedback event data includes a 3GP file; the at least one feedback event data includes an MP4 file; and the at least one feedback event data includes proprietary vibra command data.

The image decoder may be configured to read a part of the metadata header to determine the length of the data.

The event decoder may comprise an audio/tactile signal decoder configured to decode the at least one metadata of the animated image and determine at least one audio/tactile signal based on the at least one touch parameter; and wherein the event output may comprise at least one transducer configured to generate an output based on the at least one audio/tactile signal, such that the audio/tactile signal is associated with the animated image displayed.

The audio/tactile signal decoder may comprise at least one of: an audio signal decoder configured to decode audio data; a tactile effect signal decoder configured to decode tactile effect signal data; a vibra effect signal decoder configured to decode vibra effect control data; and an audio/tactile effect signal decoder may be configured to decode at least one of: audio signal data; tactile effect signal data; and vibra effect control data.

The transducer may comprise at least one of: at least one acoustic transducer configured to generate an acoustic wave based on the at least one audio/tactile signal; at least one audio display transducer configured to displace a display to generate an acoustic wave based on the at least one audio/tactile signal; at least one audio display transducer configured to displace a display to generate a localised tactile displacement based on the at least one audio/tactile signal; at least one vibra transducer configured to generate a vibra displacement based on the at least one audio/tactile signal.

The apparatus may further comprise: a display configured to display the animated image comprising the substantially static region and the dynamic region.

The at least one touch parameter may comprise at least one of: a determination of at least one object neighbouring a display on which at least one dynamic region of the animated image is output; a determination of at least one object neighbouring a display location; a determination of at least one object neighbouring a display size; a determination of a number of objects neighbouring a display; a determination of at least one object neighbouring a display speed; and a determination of at least one object neighbouring a display direction.

The apparatus may further comprise a touch sensor configured to sense at least one object neighbouring a display and determine at least one of: the an object neighbouring a display on which at least one dynamic region of the animated image is output; the at least one object neighbouring a display location; the at least one object neighbouring a display size; the number of objects neighbouring a display; the at least one object neighbouring a display speed; and the at least one object neighbouring a display direction.

The event decoder may be configured to: compare the at least one touch parameter control data and the at least one touch parameter; and decode the at least feedback event from an at least one feedback event data associated with the at least one image touch parameter control data based on a positive comparison.

The event decoder may comprise a tactile effect generator configured to output at least one audio/tactile signal based on whether the object neighbouring the display is within an at least one touch parameter control data display location.

The event decoder may be configured to control the output of at least one audio/tactile signal based on the at least one touch parameter.

The event decoder may be configured to control at least one of: playing the output of the at least one audio/tactile signal; pausing the output of the at least one audio/tactile signal; stopping the output of the at least one audio/tactile signal; rewinding the output of the at least one audio/tactile signal; and fast forwarding the output of the at least one audio/tactile signal.

The image decoder may be configured to control the output of the animated image comprising the substantially static region and the dynamic region based on the at least one touch parameter.

The image decoder may be configured to control the output by at least one of: play the output of the animated image; pause the output of the animated image; stop the output of the animated image; rewind the output of the animated image; and fast forward the output of the animated image.

According to a sixth aspect there is provided an apparatus comprising: an animated image generator configured to generate at least one animated image comprising at least two frames for generating a dynamic region and at least one data region for generating a substantially static region to be displayed on a displayed user interface and at least one touch parameter control data; a feedback event generator configured to generate at least one feedback event indicator configured to indicate a feedback event to be output; and a processor configured to combine the at least one feedback event indicator with the at least one animated image to be displayed on a displayed user interface.

The processor may comprise at least one of: an upioader configured to upload the at least one animated image and the at least one feedback event indicator to a content server; a transmitter configured to transmit control data for selecting the at least one animated image and at least one feedback event indicator from a server apparatus; a transmitter configured to transmit a multimedia message service message comprising the at least one animated image and the at least one feedback event indicator; a transmitter configured to transmit a network message comprising the at least one animated image and the at least one feedback event indicator; a transmitter configured to transmit a server message comprising the at least one animated image and the at least one feedback event indicator; and a transmitter configured to transmit an application message comprising the at least one animated image and the at least one feedback event indicator.

The at least one feedback event signal indicator may comprise at least one of; apparatus control data; camera control data; text data; a memory location comprising data; a tactile feedback signal file; a recorded audio signal; an indicator for selecting at least one predefined audio signal; at least one base tactile feedback signal; at least one tactile feedback signal processing characteristic; at least one tactile feedback signal processing characteristic value; a tactile feedback signal link to a memory location within an apparatus; and a tactile feedback signal link to a network location external to an apparatus.

The feedback event generator may comprise a tactile effect generator configured to generate at least one tactile effect signal indicator configured to indicate a tactile effect signal to be output and wherein the processor may be configured to combine the at least one tactile effect signal indicator with the at least one animated image to be displayed on a displayed user interface.

The animated image generator may comprise at least one of: a selector configured to select at least one defined animated image; a touch parameter control selector configured to select at least one touch based control indicator; and an animated image generator configured to generate at least one defined animated image.

The at least one touch based control indicator may comprise at least one of: a touch location; a defined number of touches; a touch pressure; a touch duration; a touch speed; and a touch direction.

According to a seventh aspect there is provided an apparatus comprising: means for receiving at least one animated image and at least one metadata, wherein the at least one animated image comprises at least two frames for generating a dynamic region and at least one data region for generating a substantially static region, and the at least one metadata comprises at least one audio/tactile signal data and at least one touch parameter control data; means for receiving at least one touch parameter; means for separating the at least one animated image and the at least one metadata to generate an animated image comprising the substantially static region and the dynamic region; means for decoding the at least one metadata of the animated image to determine at least one feedback event based on the at least one touch parameter; and means for producing an output based on the at least one feedback event, such that the feedback event is associated with the animated image displayed.

The means for separating the at least one animated image and the at least one metadata to generate an animated image comprising the substantially static region and the dynamic region may comprise means for reading a header of the metadata to determine at least one feedback event data, wherein the feedback event data may comprise at least one of: a URI link to audio data; a URI link to a tactile data; a URI link to a vibra control data; audio data; tactile data; camera control data; apparatus control data; a URI to text data; text data; and an encoding format of the audio/tactile signal data.

The means for separating the at least one animated image and the at least one metadata to generate an animated image comprising the substantially static region and the dynamic region may comprise means for reading a header of the metadata to determine at least one touch parameter control data comprises at least one of: touch location control; touch direction control; touch speed control; vibra control; and the output location for the audio/tactile signal data.

The means for separating the at least one animated image and the at least one metadata to generate an animated image comprising the substantially static region and the dynamic region may comprise means for reading a first part of a metadata header to determine at least one of: the at least one feedback event data is an URI to an audio file; the at least one feedback event data is any audio data; the at least one feedback event data is audio data that should be only audible; the at least one feedback event data is audio data that should be only felt as localized haptic feedback; the at least one feedback event data is audio data that should drive a vibra; the at least one feedback event data is proprietary vibra control command data; the at least one feedback event data is control data to take a picture using a front camera; the at least one feedback event data is control data to take a picture using a rear camera; the at least one feedback event data is control data to actuate the camera flash lighting; the at least one feedback event data is control data to make a phone call; and the at least one feedback event data is control data to operate a stored routine within the apparatus.

The means for separating the at least one animated image and the at least one metadata to generate an animated image comprising the substantially static region and the dynamic region may comprise means for reading a second part of a metadata header to determine at least one of: the at least one feedback event data includes a FLAG audio data; the at least one feedback event data includes plain AMR-NB audio data; the at least one feedback event data includes plain AAC audio data; the at least one feedback event data includes plain DD+ audio data; the at least one feedback event data includes linear 16-bit PCM audio data; the at least one feedback event data includes a 3GP file; the at least one feedback event data includes an MP4 file; and the at least one feedback event data includes proprietary vibra command data.

The means for separating the at least one animated image and the at least one metadata to generate an animated image comprising the substantially static region and the dynamic region may comprise means for reading a part of the metadata header to determine the length of the data.

The means for decoding the at least one metadata of the animated image to determine at least one feedback event based on the at least one touch parameter may comprise means for decoding the at least one metadata of the animated image and determine at least one audio/tactile signal based on the at least one touch parameter; and wherein the means for producing an output based on the at least one feedback event, such that the feedback event is associated with the animated image displayed may comprise means for generating an output based on the at least one audio/tactile signal, such that the audio/tactile signal is associated with the animated image displayed.

The means for decoding the at least one metadata of the animated image and determine at least one audio/tactile signal based on the at least one touch parameter may comprise at least one of: means for decoding audio data; means for decoding tactile effect signal data; means for decoding vibra effect control data; and means for decoding at least one of: audio signal data; tactile effect signal data; and vibra effect control data.

The means for generating an output based on the at least one audio/tactile signal may comprise at least one of: means for generating an acoustic wave based on the at least one audio/tactile signal; means for displacing a display to generate an acoustic wave based on the at least one audio/tactile signal; means for displacing a display to generate a localised tactile displacement based on the at least one audio/tactile signal; and means for generating a vibra displacement based on the at least one audio/tactile signal.

The apparatus may further comprise means for displaying the animated image comprising the substantially static region and the dynamic region.

The means for receiving at least one touch parameter may comprise at least one of: means for determining of at least one object neighbouring a display on which at least one dynamic region of the animated image is output; means for determining of at least one object neighbouring a display location; means for determining a size of at least one object neighbouring a display; means for determining a number of objects neighbouring a display; means for determining a speed of at least one object neighbouring a display; and means for determining a direction of at least one object neighbouring a display.

The apparatus may further comprise means for sensing at least one object neighbouring a display and means for determining at least one of: an object neighbouring a display on which at least one dynamic region of the animated image is output; a location of at least one object neighbouring a display; a size of at least one object neighbouring a display; a number of objects neighbouring a display; a speed of at least one object neighbouring a display; and a direction of the at least one object neighbouring a display.

The means for decoding the at least one metadata of the animated image to determine at least one feedback event based on the at least one touch parameter may comprise: means for comparing the at least one touch parameter control data and the at least one touch parameter; and means for decoding the at least feedback event from an at least one feedback event data associated with the at least one image touch parameter control data based on a positive comparison.

The means for decoding the at least one metadata of the animated image to determine at least one feedback event based on the at least one touch parameter may comprise means for outputting at least one audio/tactile signal based on whether the object neighbouring the display is within an at least one touch parameter control data display location.

The means for decoding the at least one metadata of the animated image to determine at least one feedback event based on the at least one touch parameter may comprise means for controlling the output of at least one audio/tactile signal based on the at least one touch parameter.

The means for controlling the output of at least one audio/tactile signal based on the at least one touch parameter may comprise at least one of: means for controlling playing the output of the at least one audio/tactile signal; means for controlling pausing the output of the at least one audio/tactile signal; means for controlling stopping the output of the at least one audio/tactile signal; means for controlling rewinding the output of the at least one audio/tactile signal; and means for controlling fast forwarding the output of the at least one audio/tactile signal.

The means for decoding the at least one metadata of the animated image to determine at least one feedback event based on the at least one touch parameter may comprise means for controlling the output of the animated image comprising the substantially static region and the dynamic region based on the at least one touch parameter.

The means for controlling the output of the animated image comprising the substantially static region and the dynamic region based on the at least one touch parameter may comprise at least one of: means for controlling playing the output of the animated image; means for controlling pausing the output of the animated image; means for controlling stopping the output of the animated image; means for controlling rewinding the output of the animated image; and means for controlling fast forwarding the output of the animated image.

According to an eighth aspect there is provided an apparatus comprising: means for generating at least one animated image comprising at least two frames for generating a dynamic region and at least one data region for generating a substantially static region to be displayed on a displayed user interface and at least one touch parameter control data; means for generating at least one feedback event indicator configured to indicate a feedback event to be output; and means for combining the at least one feedback event indicator with the at least one animated image to be displayed on a displayed user interface.

The means for combining the at least one feedback event indicator with the at least one animated image to be displayed on a displayed user interface may comprise at least one of: means for uploading the at least one animated image and the at least one feedback event indicator to a content server; means for transmitting control data for selecting the at least one animated image and at least one feedback event indicator from a server apparatus; means for transmitting a multimedia message service message comprising the at least one animated image and the at least one feedback event indicator; means for transmitting a network message comprising the at least one animated image and the at least one feedback event indicator; means for transmitting a server message comprising the at least one animated Image and the at least one feedback event indicator; and means for transmitting an application message comprising the at least one animated image and the at least one feedback event indicator.

The at least one feedback event signal indicator may comprise at least one of: apparatus control data; camera control data; text data; a memory location comprising data; a tactile feedback signal file; a recorded audio signal; an indicator for selecting at least one predefined audio signal; at least one base tactile feedback signal; at least one tactile feedback signal processing characteristic; at least one tactile feedback signal processing characteristic value; a tactile feedback signal link to a memory location within an apparatus; and a tactile feedback signal link to a network location external to an apparatus.

The means for generating at least one feedback event indicator configured to indicate a feedback event to be output may comprise means for generating at least one tactile effect signal indicator configured to indicate a tactile effect signal to be output and wherein the means for combining the at least one feedback event indicator with the at least one animated image to be displayed on a displayed user interface may comprise means for combining the at least one tactile effect signal indicator with the at least one animated image to be displayed on a displayed user interface.

The means for generating at least one animated image comprising at least two frames for generating a dynamic region and at least one data region for generating a substantially static region to be displayed on a displayed user interface and at least one touch parameter control data may comprise at least one of: means for selecting at least one defined animated image; means for selecting at least one touch based control indicator; and means for generating at least one defined animated image.

The at least one touch based control indicator may comprise at least one of: a touch location; a defined number of touches; a touch pressure; a touch duration; a touch speed; and a touch direction.

A computer program product stored on a medium for causing an apparatus to may perform the method as described herein.

An electronic device may comprise apparatus as described herein.

A chipset may comprise apparatus as described herein.

### SUMMARY OF FIGURES

For better understanding of the present invention, reference will now be made by way of example to the accompanying drawings in which:

FIG. 1 shows schematically an apparatus suitable for employing some embodiments;

FIG. 2 shows schematically an example tactile audio display with transducer suitable for implementing some embodiments;

FIG. 3 shows schematically audio/tactile signal generation apparatus for enhancing cinemagraph displays;

FIG. 4 shows a flow diagram of the operation of the audio/tactile signal generation apparatus according to some embodiments;

FIG. 5 shows schematically audio/tactile signal generation apparatus for enhancing cinemagraph displays implemented with 2 piezo actuators according to some embodiments;

FIG. 6 shows a flow diagram of the operation of the audio/tactile signal generation apparatus using a tactile input according to some embodiments;

FIG. 7 shows schematically a tactile effect cinemagraph generator according to some embodiments;

FIG. 8 shows a flow diagram of the operation of the tactile effect cinemagraph generator as shown in FIG. 7 according to some embodiments;

FIG. 9 shows an example tactile effect generator user interface;

FIG. 10 shows examples series of possible example lists or options for the configuration of tactile effects according to some embodiments; and

FIG. 11 shows a flow diagram of the operation of the application of the example list and options to a base tactile effect signal according to some embodiments.

### DESCRIPTION OF EXAMPLE EMBODIMENTS

The concept of embodiments of the application is to combine audio signals and/or tactile effect signals to both online and off-line cinemagraphs (animated images). This can be implemented in the example shown herein by adding metadata including audio/tactile effect signals or in some embodiments the link to or a memory indicator of the audio/tactile effect signal.

In the following examples the cinemagraph or animated image is described with regards to a graphical in-line format (GIF) format as these are typically the most common file format for cinemagraphs. However use of metadata as described herein can be implemented in any suitable image format.

Furthermore in some embodiments as described herein the audio/tactile effect signal can be triggered or controlled based on a touch detected with respect to the image. In other words the image can be interactively controlled as well is interacting with the viewer.

Thus by adding audio/tactile effect signals to the cinemagraph the richness of the user experience is increased.

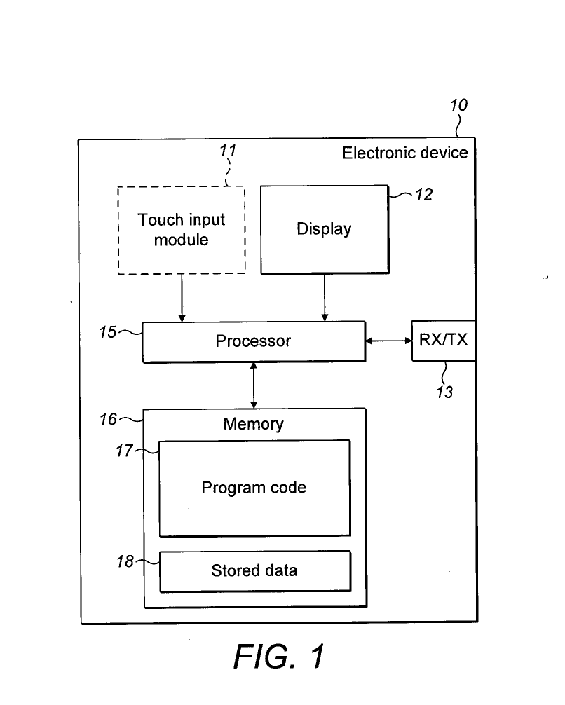

With respect to FIG. 1 a schematic block diagram of an example electronic device 10 or apparatus on which embodiments of the application can be implemented. The apparatus 10 is such embodiments configured to provide improved image experiences.

The apparatus 10 is in some embodiments a mobile terminal, mobile phone or user equipment for operation in a wireless communication system. In other embodiments, the apparatus is any suitable electronic device configured to provide an image display, such as for example a digital camera, a portable audio player (mp3 player), a portable video player (mp4 player). In other embodiments the apparatus can be any suitable electronic device with touch interface (which may or may not display information) such as a touch-screen or touch-pad configured to provide feedback when the touch-screen or touch-pad is touched. For example in some embodiments the touch-pad can be a touch-sensitive keypad which can in some embodiments have no markings on it and in other embodiments have physical markings or designations on the front window. The user can in such embodiments be notified of where to touch by a physical identifier—such as a raised profile, or a printed layer which can be illuminated by a light guide.

The apparatus 10 comprises a touch input module or user interface 11, which is linked to a processor 15. The processor 15 is further linked to a display 12. The processor 15 is further linked to a transceiver (TX/RX) 13 and to a memory 16.

In some embodiments, the touch input module 11 and/or the display 12 are separate or separable from the electronic device and the processor receives signals from the touch input module 11 and/or transmits and signals to the display 12 via the transceiver 13 or another suitable interface. Furthermore in some embodiments the touch input module 11 and display 12 are parts of the same component. In such embodiments the touch interface module 11 and display 12 can be referred to as the display part or touch display part.

The processor 15 can in some embodiments be configured to execute various program codes. The implemented program codes, in some embodiments can comprise such routines as audio signal parsing and decoding of image data, touch processing, input simulation, or tactile effect simulation code where the touch input module inputs are detected and processed, effect feedback signal generation where electrical signals are generated which when passed to a transducer can generate tactile or haptic feedback to the user of the apparatus, or actuator processing configured to generate an actuator signal for driving an actuator. The implemented program codes can in some embodiments be stored for example in the memory 16 and specifically within a program code section 17 of the memory 16 for retrieval by the processor 15 whenever needed. The memory 15 in some embodiments can further provide a section 18 for storing data, for example data that has been processed in accordance with the application, for example pseudo-audio signal data.

The touch input module 11 can in some embodiments implement any suitable touch screen interface technology. For example in some embodiments the touch screen interface can comprise a capacitive sensor configured to be sensitive to the presence of a finger above or on the touch screen interface. The capacitive sensor can comprise an insulator (for example glass or plastic), coated with a transparent conductor (for example indium tin oxide—ITO). As the human body is also a conductor, touching the surface of the screen results in a distortion of the local electrostatic field, measurable as a change in capacitance. Any suitable technology may be used to determine the location of the touch. The location can be passed to the processor which may calculate how the user's touch relates to the device. The insulator protects the conductive layer from dirt, dust or residue from the finger.

In some other embodiments the touch input module can be a resistive sensor comprising of several layers of which two are thin, metallic, electrically conductive layers separated by a narrow gap. When an object, such as a finger, presses down on a point on the panel's outer surface the two metallic layers become connected at that point: the panel then behaves as a pair of voltage dividers with connected outputs. This physical change therefore causes a change in the electrical current which is registered as a touch event and sent to the processor for processing.

In some other embodiments the touch input module can further determine a touch using technologies such as visual detection for example a camera either located below the surface or over the surface detecting the position of the finger or touching object, projected capacitance detection, infra-red detection, surface acoustic wave detection, dispersive signal technology, and acoustic pulse recognition. In some embodiments it would be understood that ‘touch’ can be defined by both physical contact and ‘hover touch’ where there is no physical contact with the sensor but the object located in close proximity with the sensor has an effect on the sensor.

The apparatus 10 can in some embodiments be capable of implementing the processing techniques at least partially in hardware, in other words the processing carried out by the processor 15 may be implemented at least partially in hardware without the need of software or firmware to operate the hardware.

The transceiver 13 in some embodiments enables communication with other electronic devices, for example in some embodiments via a wireless communication network.

The display 12 may comprise any suitable display technology. For example the display element can be located below the touch input module and project an image through the touch input module to be viewed by the user. The display 12 can employ any suitable display technology such as liquid crystal display (LCD), light emitting diodes (LED), organic light emitting diodes (OLED), plasma display cells, Field emission display (FED), surface-conduction electron-emitter displays (SED), and Electrophoretic displays (also known as electronic paper, e-paper or electronic ink displays). In some embodiments the display 12 employs one of the display technologies projected using a light guide to the display window.

The concept of the embodiments described herein is to implement improved image experiences by enabling tactile and in some embodiments tactile and audio outputs enhancing the image output. In some embodiments the improved image experiences are further able to be controlled by touching the display at defined regions of the display with associated tactile and/or audio feedback.

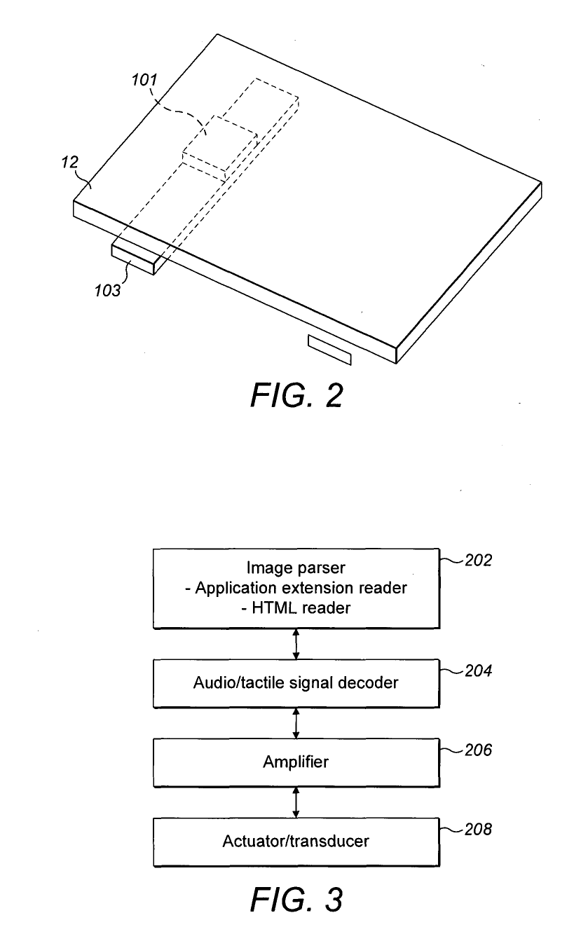

An example tactile audio display component comprising the display and tactile feedback generator is shown in FIG. 2. FIG. 2 specifically shows the touch input module 11 and display 12 under which is coupled a pad 101 which can be driven by the transducer 103 located underneath the pad. The motion of the transducer 103 can then be passed through the pad 101 to the display 12 which can then be felt by the user. The transducer or actuator 103 can in some embodiments be a piezo or piezo electric transducer configured to generate a force, such as a bending force when a current is passed through the transducer. This bending force is thus transferred via the pad 101 to the display 12.

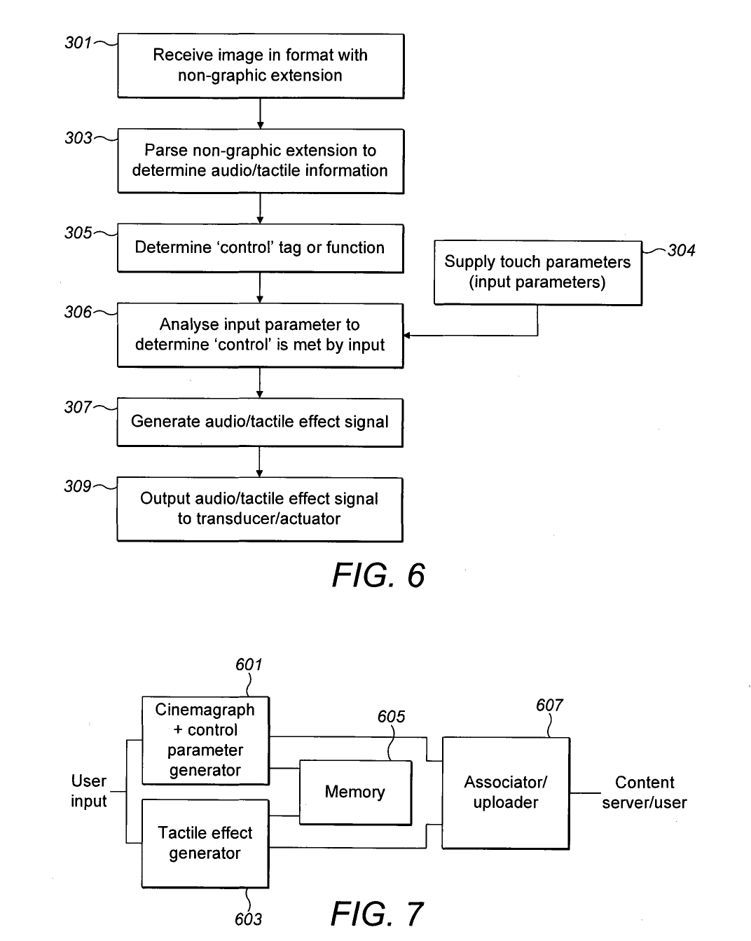

In the following examples the generation of suitable feedback event cinemagraph such as the tactile effect enhanced cinemagraphs such as shown in FIGS. 6 and 7) and the display of the enhanced feedback event cinemagraph for example the generation of the tactile effect when the enhanced cinemagraph is accessed (such as shown in FIGS. 3 to 5) are described further.

In the following example the generation of feedback event is described with respect to the example of tactile effect generation (and similarly the display of the feedback event is with respect to the example of tactile effect generation) however it would be understood that any suitable feedback event, such as apparatus control, (controlling a camera on the apparatus, controlling the radio telecommunications on the apparatus to make a call or text a number, controlling the apparatus to perform a defined routine) can be implemented using similar components and methods.

In some embodiments the feedback event (such as tactile effect) enhanced cinemagraphs and the display of the enhanced cinemagraph and generation of the feedback event (such as the tactile effect) when the enhanced cinemagraph is accessed can be performed on mobile apparatus as described herein, or on desktop or any suitable computing apparatus. In some embodiments the generated feedback event enhanced cinemagraph can be stored on a third party apparatus, such as a server, which is then accessed, downloaded or viewed by the apparatus configured to display the enhanced cinemagraph and generate the feedback event when the enhanced cinemagraph is accessed. In such embodiments the feedback event (tactile effect) enhanced cinemagraph generator can in some embodiments be seen as a www server, media server or other server type apparatus configured to pass to a further apparatus, such as described in detail herein information enabling the generation of feedback events (tactile effects) linked to an enhanced cinemagraph displayed on the display of the further apparatus.

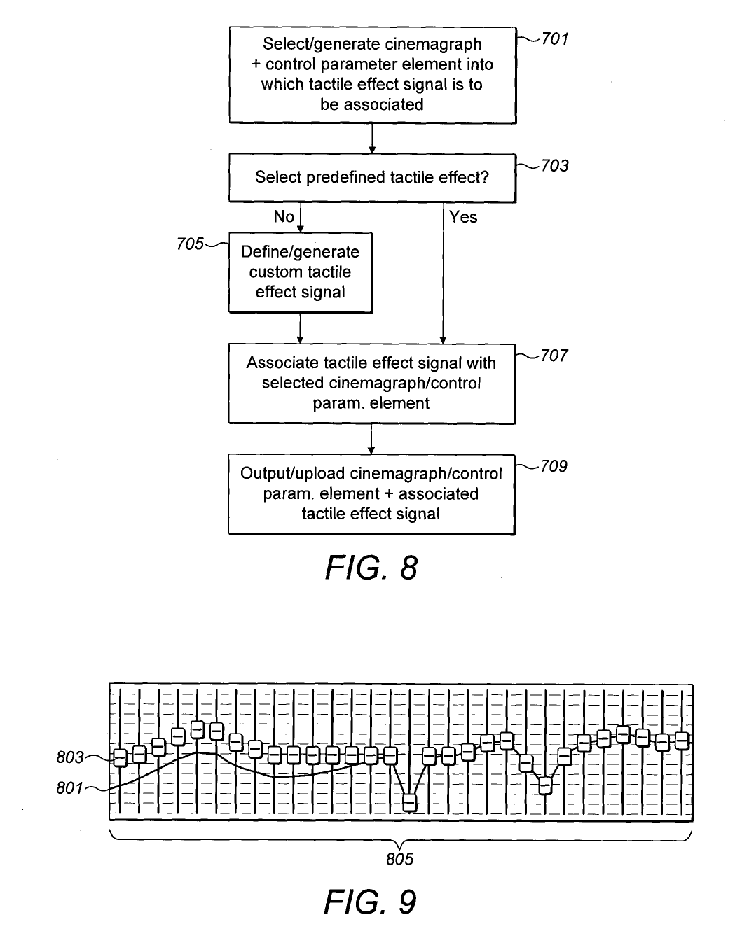

With respect to FIG. 7 an example tactile effect enhanced cinemagraph generator is shown according to some embodiments. Furthermore with respect to FIG. 8 an example operation of the tactile effect enhanced cinemagraph generator is described. Although in the following description the examples show the generation of tactile effects it would be understood that in some embodiments the generation of audio effects or more generally feedback events can be produced using the same or similar elements and operations.

For example in some embodiments a database of feedback events (such as audio effects can be selected from or feedback events (such as audio effects) recorded for example audio effects can be recorded using a microphone or the audio display operating as a microphone transducer. Similarly in some embodiments the touch based response tag defining location or position of touch, number of touches, direction of touch or speed of touch can be configured to be associated with a feedback event (such as an audio signal) to be output. In some embodiments the touch based response tag can be associated with a more than one type of feedback event. For example the feedback event can be both a tactile effect and audio signal. In some embodiments the feedback event can cause more than one type of output. For example the feedback event can enable a tactile effect and audio signal to be generated as the feedback event can be a signal where the lower frequency components are experienced as a tactile response and the higher frequency components are experienced as an audio response or vice versa. Furthermore in some embodiments the touch tag can be configured to control the playback of the feedback event (such as the audio signal) or the speed of playback of the feedback event (such as the audio signal).

In some embodiments the tactile effect enhanced cinemagraph generator comprises a cinemagraph generator (or cinemagraph and control parameter generator) 601. The cinemagraph generator can be configured to generate or select at least one cinemagraph or animated image to be displayed on a displayed user interface at a location on a display. The cinemagraph generator 601 can be configured to generate the cinemagraph in any suitable manner. For example in some embodiments the generator 601 is a graphical cinemagraph application for generating cinemagraph components, and in some embodiments control data associated with the cinemagraph and regions of the cinemagraph (for example animated regions with associated control touch related parameters at determined locations) on a display window. For example the animated image is displayed on the display and at least one of the moving or dynamic objects within the image highlighted. In some embodiments the user of the generator can be configured to select or highlight areas of the image other than the moving or dynamic objects within the image or select or deselect the moving or dynamic objects within the image.

In some embodiments the cinemagraph generator can generate and configure a touch based response tag. The touch based response tag can for example define when the feedback event is to be generated or where a feedback event (such as a tactile effect) is to be generated associated with the cinemagraph. For example the touch based response tag can be a touch location. Thus for example the touch location in some embodiments can be the location of the highlighted area as defined by the cinemagraph generator and can be the location of at least one of the moving or dynamic objects. In some embodiments the touch based response tag can be a defined number of touches, for example the tag required a double tap to initiate the feedback event such as the output of tactile effect or animation of the image. In some embodiments the touch based response tag can be a pressure of the touch, for example when the touch is greater than a defined threshold pressure then the output of the tactile effect or animation performed. In some embodiments the touch based response tag can be a duration of the touch, for example the touch when held for a defined length of time enables the output of the feedback event such as the tactile effect or the animation. Furthermore in some embodiments the touch based response tag can be a speed or direction of the touch, for example tactile effect or animation can be speeded up or slowed down dependent on the direction and speed of motion of touch on the display on the display apparatus. In some embodiments more than one touch based tag can be combined to enable complex control effects within cinemagraph or animated images, for example a first touch based tag can enable the start or stopping of playing of the tactile effect/animation, a second control the speed of the playing of the tactile effect/animation, and a third control the amplitude or volume of the tactile effect or audio signal. Furthermore in some embodiments more than one touch based tag may be associated with a single control effect, for example the start or stopping of playing the tactile effect requires both a touch at a defined location and with a defined pressure. In some embodiments more than one touch based tag can produce the same control effect, for example playing the tactile effect requires either a touch at a defined location or a touch anywhere with a defined pressure.

The control effect can be for example to play, stop, rewind or fast forward the associated tactile effect and/or the animation of the image. The addition of touch based response tags to an image can be implemented for example using a user interface menu option to select control logic options or select predefined touch based response tags.

The cinemagraph generator 601 in some embodiments can be coupled to a memory 605 configured to store defined or pre-defined cinemagraphs or templates onto which the generator 601 can customise or modify with touch based response tags.

The operation of generating or selecting a cinemagraph into which a tactile effect signal is to be associated is shown in FIG. 8 by step 701.

In some embodiments the enhanced cinemagraph generator can further comprise a tactile effect generator 603 (or more generally a feedback event indicator generator) configured to generate a tactile feedback signal or indicator configured to indicate a tactile feedback signal to be output. The indicator or signal can be any suitable indicator. For example in some embodiments the tactile effect generator 603 is configured to use a defined or predefined tactile effect signal. In some embodiments the tactile effect generator 603 can be coupled to a memory 605 configured to supply suitable defined tactile effect signals or indicators to signals.

In some embodiments the tactile effect generator 603 is configured to offer or output a list of predefined or preset files or indicators of tactile effect signals from where the user can select from. The preset files can be for example a ‘Click’ tactile effect signal, a ‘Button’ tactile effect signal, a ‘Pillow’ tactile effect signal and a ‘Water’ tactile effect signal.

The operation of checking whether the tactile effect selected is predefined effect is shown in FIG. 7 by step 703.

Where the tactile effect selected is not a predefined effect then the tactile effect generator can be configured to generate or define a custom tactile effect signal. In some embodiments the tactile effect generator 603 can be configured to ‘capture’ a tactile effect from the tactile audio display. In other words the user of the apparatus can be configured to record a tactile effect by tapping or moving the display at a point or area which can then be used as the tactile effect.

In some embodiments the ‘capture’ or ‘recording of the tactile effect can be performed using a microphone input. The microphone input can be used in such embodiments to define the haptic feedback. The tactile effect generator 603 in such embodiments can record a certain or defined time period of audio and use the recorded audio as the selected tactile feedback.

In some embodiments the tactile effect generator can be configured to process the recorded audio. For example in some embodiments the tactile effect generator can be configured to perform a low-pass filtering to filter out the audible higher frequencies, or in some embodiments perform pitch shifting to pitch shift the audible frequencies to haptic feedback frequencies. In some embodiments the tactile effect generator 603 can be configured to perform noise cancellation to remove background noise contamination of the tactile effect signal.

As shown herein the tactile effect or haptic feedback signal is an audio signal in some embodiments the definition of the tactile effect can be created within a custom tactile effect generator program or application where tactile effects can be generated and ‘tested’.

In some embodiments the custom tactile effect generator program or application can, as shown in FIG. 9 define the haptic feedback waveform 801 using a graphic equalizer type of control. In this case the x axis 805 would be time. The time (in other words the length of the haptic effect signal) in some embodiments can be user definable in which case there would be more or less knobs 803 (or sliders) or the time resolution of each knob (slider) 803 would change. In some embodiments the time of the haptic effect signal is fixed.

In some embodiments the tactile effect signal (or haptic feedback) can be defined as a link to a tactile effect signal or haptic feedback file that is elsewhere. For example an HTML link. In some embodiments the link or indicator can allow the tactile effect generating apparatus to generate the tactile effect to define the tactile effect signal being output. In other words in some embodiments the tactile effect signal is defined completely by the tactile effect generator, and in some embodiments the enhanced cinemagraph tactile effect generator 603 defines an indicator or link which is then read or received by the tactile effect generator apparatus which can then define or generate the tactile effect signal to be output based on the indicator or signal indicator.

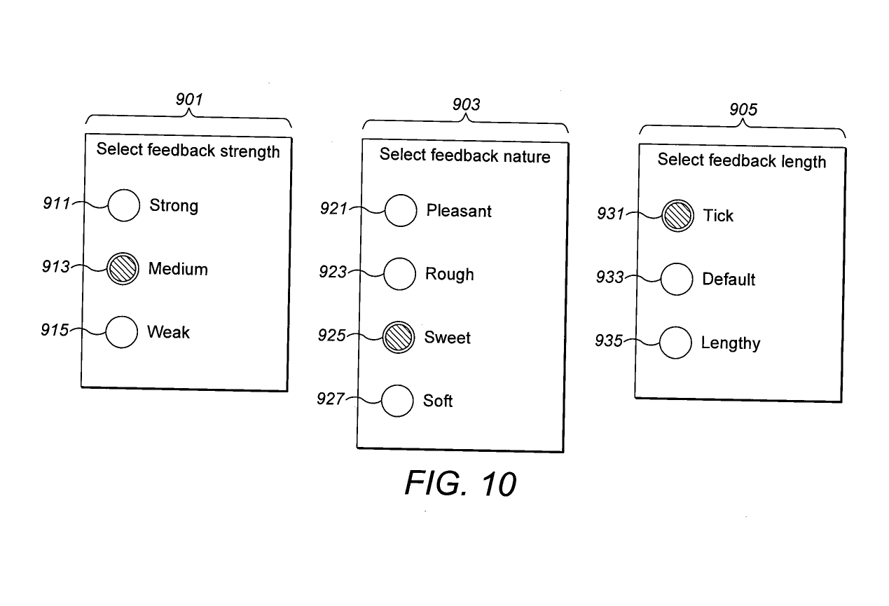

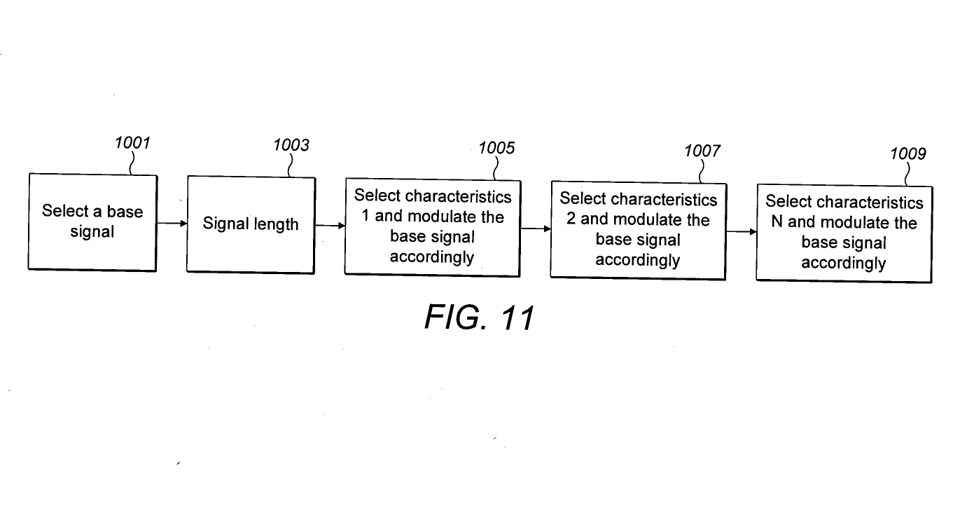

In some embodiments the tactile effect generator 603 can be further configured to permit the user to define the nature or the characteristics of the feedback. In some embodiments the tactile effect generator can be configured to accept user interface inputs in the form of radio button option selections, menu selections or switched inputs which select one from a list of multiple adjectives from which the user can select from. With respect to FIG. 10 a series of possible example lists or options, each with multiple option variables from which at least one can be selected. Furthermore with respect to FIG. 11 an operation of applying the example lists or options to defined base signal is shown.

In some embodiments the base signal can be selected by the tactile effect generator. As has been discussed the base signal can be obtained using any suitable method.

The operation of selecting the base signal is shown in FIG. 11 by step 1001.

A first list is a ‘feedback length’ option 905 list. The ‘feedback length’ option 905 list can for example as shown in FIG. 10 have the values of ‘Tick’ 931, ‘Default’ 933 and ‘Lengthy’ 935. The selection of the ‘feedback length’ option 905 can in some embodiments cause the tactile effect generator to lengthen or shorten the output signal. For example a ‘Tick’ option selection can cause the tactile effect generator to output a short <0.5 s length signal, a ‘default’ option selection can cause the tactile effect generator to output a medium 0.5 s length signal and the ‘lengthy’ option selection can cause the tactile effect generator to output a long >1 s length signal.

The operation of defining the signal length is shown in FIG. 11 by step 1003.

A second list is a ‘feedback strength’ option 901 list. The ‘feedback strength’ option 901 list can for example as shown in FIG. 10 have the values of ‘Strong’ 911, ‘Medium’ 913 and ‘Weak’ 915. The selection of the ‘feedback strength’ option 901 can in some embodiments cause the tactile effect generator to apply a gain or attenuation factor to the base signal. For example a ‘Strong’ option selection can apply a gain to the base signal, a ‘Medium’ option selection can retain the base signal unmodified and the ° Weak′ option selection can attenuate the base signal.

The selection and application of a first characteristic or option is shown in FIG. 11 by step 1005.

A third list is a ‘feedback nature’ option list 903. The ‘feedback nature’ option 903 list can for example as shown in FIG. 10 have the values of ‘Pleasant’ 921, ‘Rough’ 923, ‘Sweet’ 925 and ‘Soft’ 927. The selection of the ‘feedback nature’ option 901 can in some embodiments cause the tactile effect generator to apply a defined frequency band filtering to the base signal.

The selection and application of a second characteristic or option is shown in FIG. 11 by step 1005.

It would be understood that in some embodiments there may be more than two characteristics chosen. For example with respect to FIG. 11 the selection and application of a N'th characteristic or option is shown in step 1007. Furthermore it is understood that in some embodiments there can be fewer than two characteristics chosen. Furthermore it would be understood that the characteristic or option selected can be associated with any suitable processing of the tactile effect signal (or audio signal).

In some embodiments the tactile signal or indicator can comprise at least one of: a tactile feedback signal file, a tactile feedback signal link to a memory location within an apparatus; and a tactile feedback signal link to a network location external to an apparatus.

In some embodiments the tactile effect generator can be configured to output the defined or selected tactile effect signal or signal indicator to a processor or an associator/uploader 607.

As shown in FIG. 8 the operation of generating or defining the custom tactile effect signal is shown in step 705.

In some embodiments the tactile effect user interface element generator comprises a processor or an associator/uploader 607 configured to associate the tactile feedback signal or signal indicator with the at least one enhanced cinemagraph and control element to be displayed on a displayed user interface at the location on the display. In some embodiments this can comprise uploading within a defined file format supported by a server hosting the enhanced cinemagraph information or a suitable user equipment or electronic apparatus suitable for displaying the enhanced cinemagraph. The defined file format can be considered to be a suitable output or output means configured to output the at least one enhanced cinemagraph to be displayed on a displayed user interface at a location on a display and the tactile feedback signal indicator.

For example in some embodiments the associator can be configured to transmit a multimedia message service message comprising the at least one enhanced cinemagraph and a tactile feedback signal indicator. In some embodiments the associator 607 can be configured to transmit a network message comprising the at least one enhanced cinemagraph and the tactile feedback signal indicator. In some further embodiments the associator 607 can be configured to transmit a server message comprising the at least one enhanced cinemagraph and the tactile feedback signal indicator. Furthermore in some embodiments the associator 607 can be configured to transmit an application message comprising the at least one enhanced cinemagraph and the tactile feedback signal indicator.

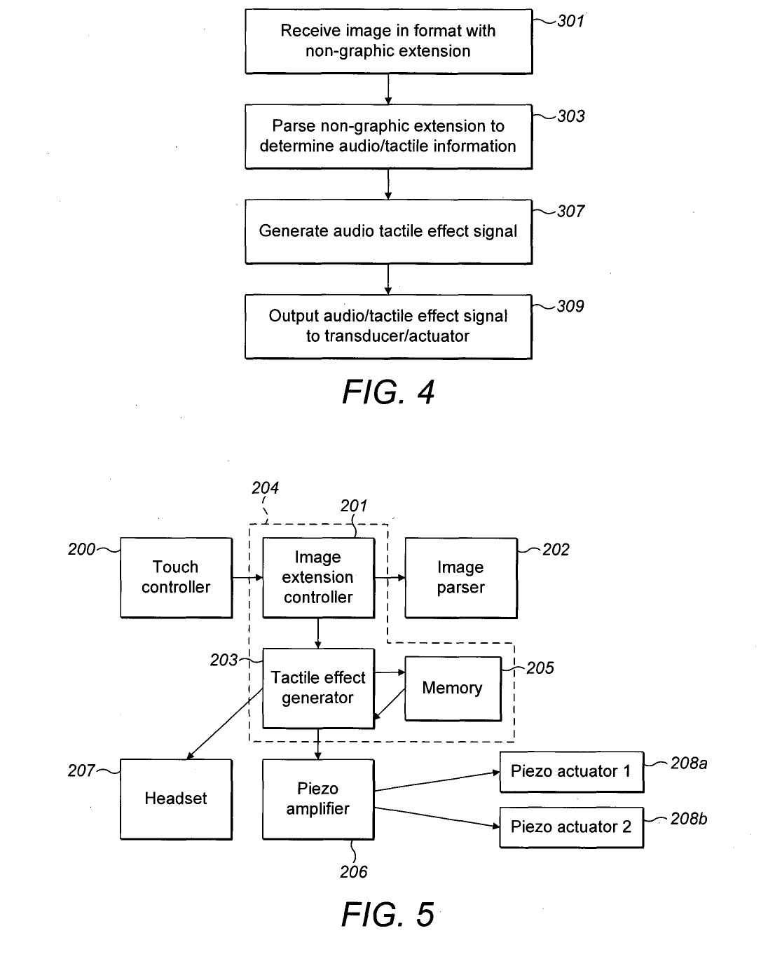

With respect to FIG. 3 an example enhanced cinemagraph or animated graphic enhancement apparatus is shown in further detail. Furthermore with respect to FIG. 4 the operation of the example enhanced cinemagraph or animated graphic enhancement apparatus is described. In the following example the enhancement is with respect the display of tactile effects, however it would be appreciated that this can be generalised to the output or display of any event feedback using similar apparatus and operations.

In some embodiments the image enhancement apparatus comprises an image parser 202. The image parser 202 can be configured to receive the image data. The image data can be received either from memory internal to the apparatus or in some embodiments received via the transceiver from a separate apparatus.

The graphics file format can be any suitable file format. For example the graphics file format can be any of the following raster format files. Such as graphics interchange format (GIF), interleaved bit map (ILBM), pixel, PhotoLine Document (PLD), multiple image network graphics (MNG), animated portable network graphics (APNG), photoshop (PSD), SMIL (a html-like markup language to describe multimedia presentations, and experimental computing facility (XCF) formats.

In the following examples a GIF the format is used as an example for the cinemagraph or animated image format.

The image parser 202 can be configured to receive the image data and parse or separate the image the format into image data and metadata which is associated with the image, for example audio and/or tactile effect signal and control data (for example the touch based response tag or tags).

The operation of receiving the image in the format with a non-graphic extension is shown in FIG. 4 by step 301.

For example the GIF file can in some embodiments comprise metadata in the form of an application extension. The application extension in some embodiments can comprise application specific information and has no upper block limit. In some embodiments the application extension can comprise at least one of audio signal, audio signal link or lookup reference data, a tactile effect signal, and a tactile effect signal link or lookup reference.

In some embodiments the GIF metadata comprises comment extension data. The comment extension data can comprise textual information which is not part of the actual graphics in the GIF datastream. In some embodiments the comment extension can be used to store at least one of audio signal, audio signal link or lookup reference data, a tactile effect signal, and a tactile effect signal link or lookup reference.

In some embodiments the image parser 202 can read the metadata (such as the application extension or comment extension with regards to GIF file format) which also comprises control data or information with regards to the audio/tactile effect signals.

The image parser 202 can be configured to pass the parsed metadata to an audio/tactile signal decoder 204.

The operation of parsing the non-graphic extension data or metadata to determine audio/tactile information is shown in FIG. 4 by step 303.

In some embodiments the enhancement apparatus comprises an audio/tactile signal decoder 204 or more generally an event decoder. The audio/tactile signal decoder 204 can be configured to receive the parsed data from the image parser 202 and decode the data in a manner suitable for generating an audio/tactile effect signal. More generally the event decoder can be configured to decode the data to enable the generation of a feedback event.

For example an application extension to cover audio data could be the following:

Header byte1:

0=the data is an URI to an audio file
1=the data is any audio data
2=the data is audio data that should be only audible
3=the data is audio data that should be only felt as localized haptic feedback (tactile effect signal)
4=the data is audio data that should drive vibra (vibra effect signal)
5=the data is proprietary vibra control command data (vibra effect signal)

Header byte 2 (if byte1=1, otherwise ignore):

0=the data includes plain AMR-NB audio data
1=the data includes plain AAC audio data
2=the data includes plain DD+ audio data
3=the data includes linear 16-bit PCM audio data
4=the data includes a 3GP file
5=the data includes an MP4 file
100=the data includes proprietary vibra command data format A
101=the data includes proprietary vibra command data format B
Header bytes 3-7
defines the length of the data

### Data

audio the link (where Header byte1=0)
or audio data (where Header byte1=1)
or audio data that should be only audible (where Header byte1=2)
or audio data that should be only felt as localized haptic feedback (tactile effect signal) (where Header byte1=3)
or audio data that should drive vibra (vibra effect signal) (where Header byte1=4) or vibra control command data (where Header byte1=5)

The audio/tactile signal decoder 204 can thus process this information to determine the type of audio encoding used, the length of the audio data, where the audio data is a file and then using this information decode the file, or retrieve and decode the file in order to generate a suitable audio signal. Similarly the audio/tactile decoder 204 can be configured to process the information to determine where the audio data is a file to be output by any means (Header byte=1), where the audio is to be output as an audio signal only (Header byte=2), where the audio is to be output by the localised haptic output for example by the audio display (Header byte=3), where the audio is to be output as a vibra signal (Header byte=4). In some embodiments the audio/tactile signal decoder 204 can be configured to process the information to determine (from the header information) where the file is not audio data but vibra control data, such as proprietary vibra control data (Header byte=5). Furthermore in some embodiments, such as shown herein, the audio/tactile signal decoder 204 can be configured to determine which format of vibra control data is in the body of the file and therefore decode the file accordingly before outputting the control signals to the vibra.

In some embodiments the audio/tactile decoder 204 can be configured to determine that the audio data is PCM or uncompressed form data.

In the example data shown above there is one feedback for the file, however it would be understood that in some embodiments there can be multiple feedback areas.

In some embodiments the metadata can describe or define information from which area of the cinemagraph the feedback comes from. Furthermore in some embodiments the metadata or the can define other types of feedbacks, for example camera flash, or in some embodiments apparatus or device actions, for example controlling the apparatus to take a photo, or to record and generate a new cinemagraph (by touching an area in the cinemagraph), or make a phone call to a phone number defined in the metadata.

In some embodiments the file can define separate feedback for hovering and physical touches.

For example a further example of metadata or file format can be where the values in bold are the memory location in bytes.

1 to 4 Amount of feedback signals in the file
5 to 8 Length of the first feedback data in bytes
   9 Data type
      0=the data is an URL to an audio file
      1=the data is any audio data
      2=the data is audio data that should be only audible
      3=the data is audio data that should be only felt as localized haptic feedback (tactile effect signal)
      4=the data is audio data that should drive vibra (vibra effect signal)
      5=the data is proprietary vibra control command data (vibra effect signal)
      6=the data is device control data
      7=the data is text to be displayed
      8=the data is an URL to a haptic feedback file
      9=the data is an URL to a text file
   10 “Data format ((f byte9>=1 AND <=4, otherwise ignore)”
      0=the data includes plain AMR-NB audio data
      1=the data includes plain AAC audio data
      2=the data includes plain DD+ audio data
      3=the data includes linear 16-bit PCM audio data
      4=the data includes a 3GP the
      5=the data includes an MP4 the
      100=the data includes proprietary vibra command data format A
      101=the data includes proprietary vibra command data format B
      200=the data is a control command to ignite camera led/flash
      201=the data is a control command to take a picture using main camera
   202=the data is a control command to take a pitcure using front camera
      203=the data is a control command to make a phone call to a phone number specified in the net data
   11 Shape of the feedback signal area
      0=Square
      1=Circle
      2=Oval
   12 “Format of the feedback area information (0=absolute values in pixels, 1=relative values so that 0000 means left/up border and FFFF means right/down border)”
   13 to 19 “Feedback signal area information (e.g. If the area is a square, then bytes 12-13 would represent top left corner as a percentage (or half a percentage) from the whole cinemagraph size and bytes 14-15 would represent the bottom right corner as a percentage from the whole cinemagraph size)”
   20 “The touch type for the feedback”
      0=physical touch
      1=double tap
      101-200=hovering touch minimum distance that activates the feedback so that 101 is just above the display and 200 is the largest distance the device can support
      201-250=minimum force of the touch that activates the feedback so that 201 is the lightest press that the device considers as a strong press and 250 is the strongest press than what the device can measure
   21 to N Net data of the first feedback in the metadata
N+1 to N+4 Length of the second feedback data in bytes
   And so on . . .

Where the file from 0 to 4 is the common memory space for all of the effects/feedback elements, 5 to N is the memory space of a first feedback effect, N+1 the start of the memory for a second feedback effect and so on. It would be understood that the format of the metadata can be any suitable format and the two examples shown herein are examples only.

The audio/tactile signal decoder 204 in some embodiments can then output the decoded audio signal to an amplifier 206.

It would be understood that in some embodiments where a tactile effect signal is indicated or included then the audio/tactile signal decoder can be configured to identify the tactile effect signal and decode the enclosed tactile effect signal or retrieve and decode the tactile effect signal using the link information.

Furthermore in some embodiments, for example where a tactile audio display is implemented as part of the apparatus display, then the audio/tactile signal decoder 204 can be configured to process a single signal in other words decode an audio signal which is also a tactile effect signal.

The operation of generating the audio/tactile effect signal is shown in FIG. 4 by step 307.

The apparatus in some embodiments comprises an amplifier 206 configured to receive the audio/tactile signal from the audio/tactile signal decoder 204. The amplifier can be configured to generate a driving current (or in general a driving signal for the actuator/transducer) and output the driving current to an actuator/transducer.

The operation of outputting the audio/tactile effect signal to a transducer/actuator is shown in FIG. 4 by step 309.

In some embodiments the apparatus comprises an at least one actuator/transducer 208. The actuator/transducer 208 can be configured to generate a suitable audio/tactile signal. The at least one actuator/transducer 208 can be any suitable actuator. In the following examples a display transducer is shown which can be configured to receive a tactile feedback signal to be output by the display. However it would be understood that a vibra transducer can be employed to generate a vibrating force.

It would be understood that more generally the apparatus can in some embodiments have an event output configured to produce an output based on the at least one feedback event, such that the feedback event is associated with the animated image displayed.

With respect to FIGS. 5 and 6 a further example of an animated graphic enhancement apparatus is shown wherein the image metadata further comprises control data associated with the audio/tactile signals for the animated graphic image.

The apparatus can in some embodiments comprise the image parser 202 which is configured to receive the image in a format with a nongraphic extension.

The operation of receiving the irraage in a format with nongraphic extension is shown in FIG. 6 by step 301.

The image parser 202 can then be configured to parse and output the nongraphic extension data to the audio/tactile signal decoder 204. The image parser 202 as described herein can therefore output the metadata nongraphic extension data in the form of audio signal data, audio signal link data, tactile effect signal data, tactile effect signal link data, and control data associated with at least one of the other data types.

The operation of parsing the non-graphic extension data is shown in FIG. 6 by step 303.

The audio/tactile signal decoder 204 can in some embodiments comprise an image extension controller 201. The image extension controller can be configured to receive any parsed non-graphic extension control data and process the control data to switch or permit the generation and control of audio/tactile signals dependent on further monitored inputs.

The control data (such as the touch based tags) as described herein can be configured to control the output of audio/tactile effect signal data dependent on touch input data from a touch user interface, however it would be understood that any suitable input can be monitored. For example in some embodiments any suitable input parameter can be tested such as the apparatus motion (for example is the apparatus moving at less than a defined speed), the apparatus position (for example is the apparatus operating at home or word or at a defined location), orientation (for example is the apparatus is operating in landscape or portrait mode).

The control data from the image parser 202 can therefore, for example, define a region of the image which when touched causes or enables the generation of the audio/tactile effect signal.

The determination of the control tag or function which is associated with an audio/tactile effect signal is shown in FIG. 6 by step 305.

The image extension controller 201 thus as shown in FIG. 5 is configured to receive an input from a touch controller 200, however in some embodiments the image extension controller 201 can receive an input from a suitable sensor.

In some embodiments the apparatus comprises a touch controller 200 configured to determine any suitable touch input parameter. The touch controller 200 can then pass the touch parameter(s) to the image extension controller 201 for matching or monitoring against any control data.

The touch controller 200 can therefore in some embodiments generate and pass touch parameters such as number and location of touches, speed of motion of the touch, pressure of the touch, duration of the touch, and whether the touch is a hover touch or contact touch.

The operation of supplying the touch parameters (or input parameters) can be shown in FIG. 6 by step 304.

In some embodiments the image extension controller 201 can receive the touch parameters and the control data and analyse the input parameter to determine whether the control element has been met and where the control element has been met to enable the control function to enable the audio/tactile effect signal. The image extension controller 201 can then output the signal/link to the signal to a tactile effect generator 203.

For example where the control data defines a control enabling the generating of a tactile effect when the image is touched at a specific location, the image extension controller having determined the ‘control’ determines whether the touch location parameter is within the defined region and where the touch location is within the defined region enable the tactile effect generator 203 to generate the tactile effect signal.

The operation of analysing the input parameter to determine where the ‘control’ is met is shown in FIG. 6 by step 306.

In some embodiments the apparatus comprises a tactile effect generator 203. The tactile effect generator 203 can in some embodiments be configured to receive the output of the image extension controller and from this output generate suitable tactile effect signals (and in some embodiments suitable audio signals). In some embodiments the tactile effect generator 203 can be configured to receive the output of the image extension controller and from this output generate suitable vibra effect signals, in other words signals for controlling a vibra based on the image metadata. The vibra effect signals can be generated either in combination with or separate from the tactile effect signals and the audio signals.

In some embodiments the tactile effect generator 203 can be configured to ‘look up’ the output from the image extension controller where the output is a link. In such embodiments the tactile effect generator 203 can receive pre-saved signal data from the memory 205, or signal data retrieved externally from the apparatus via a transceiver. For example in some embodiments the tactile effect generator 203 can be configured to retrieve specific tactile effect signals from the memory in the form of a look up table dependent on the determined output signal link.

It would be understood that in some embodiments the output from image extension controller is an encoded signal which can be decoded by the tactile effect generator as described herein with respect to embodiments described in FIGS. 3 and 4.

In some embodiments, for example where the tactile effect can be ‘positioned’ on the display then the tactile effect generator 203 can in some embodiments further determine the location where the tactile effect is to be output. The apparatus in such embodiments can comprise more than one piezo-electric transducer located under the display surface at various locations and be individually controlled to generate a different tactile effect signal to each or groups of transducers. The positioning of the tactile effect can for example be resolved to be centred at the detected touch position.

In some embodiments the apparatus comprises a memory 205. The memory 205 can be configured to communicate with the tactile effect generator 203. In some embodiments the memory 305 can be configured to store suitable tactile effect “audio” signals which when passed to the piezo amplifier 206 generates suitable haptic feedback using the tactile audio display.

In some embodiments the tactile effect generator can output the generated effect to the piezo amplifier 206.

The operation of generating the audio/tactile effect signal is shown in FIG. 6 by step 307.

In some embodiments the apparatus comprises a piezo amplifier 206. The piezo amplifier 206 can be a single channel or multiple channel amplifier configured to receive at least one signal channel output from the tactile effect generator 203 and configured to generate a suitable signal to output to at least one piezo actuator. In the example shown in FIG. 5 the piezo amplifier 206 is configured to output a first actuator signal to a first piezo actuator (piezo actuator 1) 208a and a second actuator signal to a second piezo actuator (piezo actuator 2) 208b.

It would be understood that the piezo amplifier 206 can be configured to output more than or fewer than two actuator signals.

In some embodiments the apparatus comprises a first piezo actuator (piezo actuator 1), 208a configured to receive a first signal from the piezo amplifier 206 and a second piezo actuator (piezo actuator 2) 208b, configured to receive a second signal from the piezo amplifier 206. The piezo actuators are configured to generate a motion to produce the tactile feedback on the tactile audio display. It would be understood that there can be more than or fewer than two piezo actuators and furthermore in some embodiments the actuator can be an actuator other than a piezo actuator.

It would be understood that the configuration of the tactile effect generator system can differ from the tactile effect generator system apparatus shown in FIG. 5. For example in some embodiments each piezo-electric actuator is configured to be supplied a signal from an associated piezo amplifier. Thus for example the first piezo actuator (piezo actuator 1) 208a can in some embodiments receive an actuation signal from a first piezo amplifier and the second piezo actuator (piezo actuator 2) 208b receive a second actuation signal from a second piezo amplifier.

It would be understood that in some embodiments the tactile effect generator system apparatus can be configured to output audio as well as tactile signals via the piezo-electric actuators dependent on the signal generated by the tactile effect generator 203. For example it would be understood that the frequency range of the signal that is output by the tactile effect generator can be higher than the tactile signal range and thus generate an audio signal in combination with the tactile signal.

In some embodiments the audio signal output can be directed to a separate output. For example as shown in FIG. 5, the tactile effect generator system comprises a headset 207 configured to receive an audio signal from the tactile effect generator 203. In such embodiments the tactile effect generator 203 is further configured to generate not only tactile “audio” signals which are passed to the piezo actuator but configured to generate an audio signal which can be output to an external audio actuator such as the headset 207. Thus in some embodiments the tactile effect generator 203 can be configured to generate an external audio feedback signal concurrently with the generation of the tactile feedback or separate from the tactile feedback.

The operation of outputting the tactile effect signal to the piezo actuator or amplifier for controlling the piezo actuator is shown in FIG. 6 by step 309.

The use of control data would permit a use case would be where an image is sent to a sender which contains an image of the sender and a message from the sender which is spoken when the image is pressed at a defined place or region.

In some embodiments touching the image from a certain point or moving the touch the right way (or defined way) on top of the image could control the motion of the image. For example a touch at the left hand edge of the image could rewind the image or modify the image. Furthermore touching the image with a different force could furthermore control the playback of the image and/or the audio signal/tactile signal. Thus in some embodiments a light touch implemented with a touch force sensing or hovering would play a different audio signal than a stronger or normal press touch.

In some embodiments the control information can be stored in the form of a map such as a HTML <map> tag which allows an action based on the point a location on the screen.

This could be implemented by the design of the cinemagraph as they would be able to associate activity of certain areas of the cinemagraph with the dynamic image positions. This could be invited for example using HTML code such as the following

<!DOCTYPE html>
<html>
<body>
<img src=″cinemagraph_file.gif″ usemap=″#audiomap″/>
<map name=″audiomap″>

<area shape=″rect″ coords=″0,0,200,200″ href=″audio_file1.mp3″
type=″audio/mpeg″ />
<area shape=″rect″ coords=″0,200,200,400″ href=″audio_file2.mp3″
type=″audio/mpeg″ />

</map>
</body>
</html>

Although in the above example a rectangle area is defined, it Would be appreciated that any shape or area can be defined and used.

It shall be appreciated that the term user equipment is intended to cover any suitable type of wireless user equipment, such as mobile telephones, portable data processing devices or portable web browsers. Furthermore, it will be understood that the term acoustic sound channels is intended to cover sound outlets, channels and cavities, and that such sound channels may be formed integrally with the transducer, or as part of the mechanical integration of the transducer with the device.

In general, the design of various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The design of embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory used in the design of embodiments of the application may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be designed by various components such as integrated circuit modules.

As used in this application, the term ‘circuitry’ refers to all of the following:
(a) hardware-only circuit implementations (such as implementations in only analog and/or digital circuitry) and
(b) to combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone or server, to perform various functions and
(c) to circuits, such as a microprocessor(s) or a portion of a microprocessor(s), that require software or firmware for operation, even if the software or firmware is not physically present.

This definition of ‘circuitry’ applies to all uses of this term in this application, including any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or applications processor integrated circuit for a mobile phone or similar integrated circuit in server, a cellular network device, or other network device.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-30. (canceled)

31. An apparatus comprising:
an input configured to receive at least one animated image and at least one metadata, wherein the at least one animated image comprises at least two frames for generating a dynamic region and at least one data region for generating a substantially static region, and the at least one metadata comprises at least one audio/tactile signal data and at least one touch parameter control data;
a touch controller configured to receive at least one touch parameter;
an image decoder configured to separate the at least one animated image and the at least one metadata, and configured to generate an animated image comprising the substantially static region and the dynamic region;
an event decoder configured to decode the at least one metadata of the animated image and determine at least one feedback event based on the at least one touch parameter; and
an event output configured to produce an output based on the at least one feedback event, such that the feedback event is associated with the animated image displayed.

32. The apparatus as claimed in claim 31, wherein the image decoder comprises a header reader configured to read a header of the metadata to determine at least one feedback event data, wherein the feedback event data comprises at least one of:
a URI link to audio data;
a URI link to a tactile data;
a URI link to a vibra control data;
audio data;
tactile data;
camera control data;
apparatus control data;
a URI to text data;
text data; and
an encoding format of the audio/tactile signal data.

33. The apparatus as claimed in claim 32, wherein the header reader is configured to read a header of the metadata to determine at least one touch parameter control data comprises at least one of:
touch location control;
touch direction control;
touch speed control;
vibra control; and
the output location for the audio/tactile signal data.

34. The apparatus as claimed in claim 31, wherein the image decoder is configured to read at least one of a first part and a second part of a metadata header to determine at least one of:
the at least one feedback event data is an URI to an audio file;
the at least one feedback event data is any audio data;
the at least one feedback event data is audio data that should be only audible;
the at least one feedback event data is audio data that should be only felt as localized haptic feedback;
the at least one feedback event data is audio data that should drive a vibra;
the at least one feedback event data is proprietary vibra control command data;
the at least one feedback event data is control data to take a picture using a front camera;
the at least one feedback event data is control data to take a picture using a rear camera;
the at least one feedback event data is control data to actuate the camera flash lighting;
the at least one feedback event data is control data to make a phone call;
the at least one feedback event data is control data to operate a stored routine within the apparatus;
the at least one feedback event data includes a FLAC audio data;
the at least one feedback event data includes plain AMR-NB audio data;
the at least one feedback event data includes plain AAC audio data;
the at least one feedback event data includes plain DD+ audio data;
the at least one feedback event data includes linear 16-bit PCM audio data;
the at least one feedback event data includes a 3GP file;
the at least one feedback event data includes an MP4 file; and
the at least one feedback event data includes proprietary vibra command data.

35. The apparatus as claimed in claim 34, wherein the image decoder is configured to read a part of the metadata header to determine the length of the data.

36. The apparatus as claimed in claim 31, wherein the event decoder comprises an audio/tactile signal decoder configured to decode the at least one metadata of the animated image and determine at least one audio/tactile signal based on the at least one touch parameter; and
wherein the event output comprises at least one transducer configured to generate an output based on the at least one audio/tactile signal, such that the audio/tactile signal is associated with the animated image displayed.

37. The apparatus as claimed in claim 36, wherein the audio/tactile signal decoder comprises at least one of:
an audio signal decoder configured to decode audio data;
a tactile effect signal decoder configured to decode tactile effect signal data;
a vibra effect signal decoder configured to decode vibra effect control data; and
an audio/tactile effect signal decoder configured to decode at least one of: audio signal data;
tactile effect signal data; and vibra effect control data.

38. The apparatus as claimed in claim 36, wherein the at least one transducer comprises at least one of:
at least one acoustic transducer configured to generate an acoustic wave based on the at least one audio/tactile signal;
at least one audio display transducer configured to displace a display to generate an acoustic wave based on the at least one audio/tactile signal;
at least one audio display transducer configured to displace a display to generate a localised tactile displacement based on the at least one audio/tactile signal;
at least one vibra transducer configured to generate a vibra displacement based on the at least one audio/tactile signal.

39. The apparatus as claimed in claim 31, wherein the at least one touch parameter comprises at least one of:
a determination of at least one object neighbouring a display on which at least one dynamic region of the animated image is output;
a determination of at least one object neighbouring a display location;
a determination of at least one object neighbouring a display size;
a determination of a number of objects neighbouring a display;
a determination of at least one object neighbouring a display speed; and
a determination of at least one object neighbouring a display direction.

40. The apparatus as claimed in claim 39, further comprising a touch sensor configured to sense at least one object neighbouring a display and determine at least one of:
the object neighbouring a display on which at least one dynamic region of the animated image is output;
the at least one object neighbouring a display location;
the at least one object neighbouring a display size;
the number of objects neighbouring a display;
the at least one object neighbouring a display speed; and
the at least one object neighbouring a display direction.

41. The apparatus as claimed in claim 40, wherein the event decoder is configured to:
compare the at least one touch parameter control data and the at least one touch parameter;
decode the at least feedback event from an at least one feedback event data associated with the at least one image touch parameter control data based on a positive comparison.

42. The apparatus as claimed in claim 41, wherein the event decoder comprises a tactile effect generator configured to output at least one audio/tactile signal based on at least one of:
whether the object neighbouring the display is within an at least one touch parameter control data display location; and
the at least one touch parameter.

43. The apparatus as claimed in claim 42, wherein the event decoder is configured to control at least one of:
playing the output of the at least one audio/tactile signal;
pausing the output of the at least one audio/tactile signal;
stopping the output of the at least one audio/tactile signal;
rewinding the output of the at least one audio/tactile signal; and
fast forwarding the output of the at least one audio/tactile signal.

44. The apparatus as claimed in claim 31, wherein the image decoder is configured to control the output based on at least one of:
at least one touch parameter;
playing the output of the animated image;
pausing the output of the animated image;
stopping the output of the animated image;
rewinding the output of the animated image; and
fast forwarding the output of the animated image.

45. An apparatus comprising:
an animated image generator configured to generate at least one animated image comprising at least two frames for generating a dynamic region and at least one data region for generating a substantially static region to be displayed on a displayed user interface and at least one touch parameter control data;
a feedback event generator configured to generate at least one feedback event indicator configured to indicate a feedback event to be output; and
a processor configured to combine the at least one feedback event indicator with the at least one animated image to be displayed on a displayed user interface.

46. The apparatus as claimed in claim 45 wherein the processor comprises at least one of:
an uploader configured to upload the at least one animated image and the at least one feedback event indicator to a content server;
a transmitter configured to transmit control data for selecting the at least one animated image and at least one feedback event indicator from a server apparatus;
a transmitter configured to transmit a multimedia message service message comprising the at least one animated image and the at least one feedback event indicator;
a transmitter configured to transmit a network message comprising the at least one animated image and the at least one feedback event indicator;
a transmitter configured to transmit a server message comprising the at least one animated image and the at least one feedback event indicator; and
a transmitter configured to transmit an application message comprising the at least one animated image and the at least one feedback event indicator.

47. The apparatus as claimed in claim 45, wherein the at least one feedback event signal indicator comprises at least one of:
apparatus control data;
camera control data;
text data;
a memory location comprising data;
a tactile feedback signal file;
a recorded audio signal;
an indicator for selecting at least one predefined audio signal;
at least one base tactile feedback signal;
at least one tactile feedback signal processing characteristic;
at least one tactile feedback signal processing characteristic value;
a tactile feedback signal link to a memory location within an apparatus; and
a tactile feedback signal link to a network location external to an apparatus.

48. The apparatus as claimed in claim 45, wherein the feedback event generator comprises a tactile effect generator configured to generate at least one tactile effect signal indicator configured to indicate a tactile effect signal to be output and wherein the processor is configured to combine the at least one tactile effect signal indicator with the at least one animated image to be displayed on a displayed user interface.

49. The apparatus as claimed in claim 45, wherein the animated image generator comprises at least one of:
a selector configured to select at least one defined animated image;
a touch parameter control selector configured to select at least one touch based control indicator; and
an animated image generator configured to generate at least one defined animated image.

50. The apparatus as claimed in claim 49, wherein the at least one touch based control indicator comprises at least one of:
a touch location;
a defined number of touches;
a touch pressure;
a touch duration;
a touch speed; and
a touch direction.
